(19) United States
(12) Patent Application Publication
(10) Pub. No.: US 2014/0101018 A1
(43) Pub. Date: Apr. 10, 2014

(54) Dynamically Adjusted Elastic Interface

(71) Applicant: TRADING TECHNOLOGIES INTERNATIONAL, INC., Chicago, IL (US)

(72) Inventor: Brian J. Buck, Lisle, IL (US)

(73) Assignee: TRADING TECHNOLOGIES INTERNATIONAL, INC., Chicago, IL (US)

(21) Appl. No.: 13/645,208

(22) Filed: Oct. 4, 2012

(51) Int. Cl. G06Q 40/04

(52) U.S. Cl. 705/37

(57) ABSTRACT

Certain embodiments provide systems and methods for dynamic adjustment of a trading interface. An example method includes detecting a current position of a cursor with respect to a trading interface. The example method includes evaluating one or more candidate locations in the trading interface to determine at least one probable next cursor position based on at least one rule and at least one market condition. The example method includes providing an indication of the at least one probable next cursor position via the trading interface. An indication includes, for example, facilitating adjustment of the trading interface based on the one or more candidate locations to enlarge at least one of the one or more candidate locations in the trading interface.

### CROSS-REFERENCE TO RELATED APPLICATIONS

Not Applicable.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

An interactive electronic trading interface window is provided at the trading device to facilitate execution of trades via the electronic exchange. The trading interface window facilitates display of and placement of trade orders within market trading depth of a commodity, where a commodity includes anything that can be traded with quantities and/or prices. The trading interface windows enable traders to enter and execute orders, obtain market quotes, and monitor positions, for example.

The world's stock, bond, futures and options exchanges have volatile products with prices that move rapidly. To profit in these markets, traders must be able to react quickly. A skilled trader with the quickest software, the fastest communications, and the most sophisticated analytics can significantly improve his/her own or his/her firm's bottom line. The slightest speed advantage can generate significant returns in a fast moving market. In today's securities markets, a trader lacking a technologically advanced interface is at a severe competitive disadvantage.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example layout of trading interface windows on a display screen.

FIG. 5 illustrates an example dynamically adjusted layout of trading interface windows on a display screen.

FIG. 6 illustrates a block diagram representative of an example trading interface adjustment system.

FIG. 7 illustrates a flow diagram of an example method to dynamically adjust a trading interface.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The present embodiments relate to dynamic user interface adjustment. More particularly, the present embodiments relate to dynamic adjustment of a trading interface.

Electronic trading systems provide graphical user interfaces, such as trading interface windows, to facilitate electronic trading with one or more exchanges. Traders may have many trading interface windows open on a display. A cursor can be positioned over only one window at a time, but a sudden move in a market may necessitate that a trader using a trading interface move the cursor over a long distance to enter, change, and/or cancel an order for the market shown in that trading interface window.

Certain embodiments facilitate dynamic modification of a layout of one or more trading interface windows. In certain embodiments, window layout can be dynamically modified based on a current cursor position, most likely target(s) for user cursor movement, currently executing trading strategy, market conditions, etc. A trading interface window can be made “elastic” or modifiable to expand, contract, and/or otherwise adjust one or more dimensions of one or more cells or target regions constituting the trading interface window.

For example, one or more available quantities to buy or sell are shown as cells in a trading interface window. Cell(s) can be selected to facilitate a trading-related order, for example. Depending upon a determined cursor location and likely target(s) of interest within a certain distance of the determined location, one or more cells in the trading interface window may be dynamically adjusted in at least one dimension for display in the trading interface window. Thus, cells in the trading interface may be dynamically elastic based on current conditions and potential future actions, for example.

Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

Examples described herein enable dynamic adjustment of a flexible or “elastic” trading interface. The example trading interface can include one or more trading interface windows provided via one or more displays. Dynamic adjustment may be based on one or more display-, market-, and/or trade-related factors and may be limited based on one or more display-, market-, and/or trade-related constraints, for example.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Certain embodiments provide a method including detecting, using a computing device, a current position of a cursor with respect to a trading interface. The example method includes evaluating, using the computing device, one or more candidate locations in the trading interface to determine at least one probable next cursor position based on at least one rule and at least one market condition. The example method includes providing an indication of the at least one probable next cursor position via the trading interface.

Certain embodiments provide a system including a computing device configured to detect a current position of a cursor with respect to a trading interface. The example computing device is configured to evaluate one or more candidate locations in the trading interface to determine at least one probable next cursor position based on at least one rule and at least one market condition and to provide an indication of the at least one probable next cursor position via the trading interface.

Certain embodiments provide a tangible computer-readable storage medium including instructions that, when executed, cause a computing device to detect a current position of a cursor with respect to a trading interface. The example instructions, when executed, cause a computing device to evaluate one or more candidate locations in the trading interface to determine at least one probable next cursor position based on at least one rule and at least one market condition. The example instructions, when executed, cause a computing device to provide an indication of the at least one probable next cursor position via the trading interface.

Certain embodiments provide a method including detecting, using a computing device, a current position of a cursor with respect to a trading interface. The example method includes evaluating, using the computing device, one or more candidate locations in the trading interface for a next cursor position based on the current cursor position and expected cursor movement. The example method includes facilitating, using the computing device, adjustment of the trading interface based on the one or more candidate locations to enlarge at least one of the one or more candidate locations in the trading interface.

Certain embodiments provide a system including a computing device configured to detect a current position of a cursor with respect to a trading interface. The example computing device is configured to evaluate one or more candidate locations in the trading interface for a next cursor position based on the current cursor position and expected cursor movement and to facilitate adjustment of the trading interface based on the one or more candidate locations to enlarge at least one of the one or more candidate locations in the trading interface.

Certain embodiments provide a tangible computer-readable storage medium comprising instructions that, when executed, cause a computing device to at least detect a current position of a cursor with respect to a trading interface. The example instructions, when executed, cause a computing device to evaluate one or more candidate locations in the trading interface for a next cursor position based on the current cursor position and expected cursor movement. The example instructions, when executed, cause a computing device to facilitate adjustment of the trading interface based on the one or more candidate locations to enlarge at least one of the one or more candidate locations in the trading interface.

Certain embodiments provide a method including detecting, using a computing device, a current position of a cursor with respect to a trading interface. The example method includes evaluating, using the computing device, one or more candidate locations in the trading interface for a next cursor position based on the current cursor position and expected cursor movement. The example method includes facilitating, using the computing device, dynamic adjustment of the trading interface based on the one or more candidate locations to enlarge at least one of the one or more candidate locations in the trading interface, wherein a degree of enlargement of a candidate location is proportional to a likelihood that the candidate location is the next cursor position.

Certain embodiments provide a system including a computing device configured to detect a current position of a cursor with respect to a trading interface. The example computing device is configured to evaluate one or more candidate locations in the trading interface for a next cursor position based on the current cursor position and expected cursor movement and to facilitate adjustment of the trading interface based on the one or more candidate locations to enlarge at least one of the one or more candidate locations in the trading interface, wherein a degree of enlargement of a candidate location is proportional to a likelihood that the candidate location is the next cursor position.

Certain embodiments provide a tangible computer-readable storage medium comprising instructions that, when executed, cause a computing device to at least detect a current position of a cursor with respect to a trading interface. The example instructions, when executed, cause a computing device to evaluate one or more candidate locations in the trading interface for a next cursor position based on the current cursor position and expected cursor movement. The example instructions, when executed, cause a computing device to facilitate dynamic adjustment of the trading interface based on the one or more candidate locations to enlarge at least one of the one or more candidate locations in the trading interface, wherein a degree of enlargement of a candidate location is proportional to a likelihood that the candidate location is the next cursor position.

### II. EXAMPLE ELECTRONIC TRADING SYSTEM

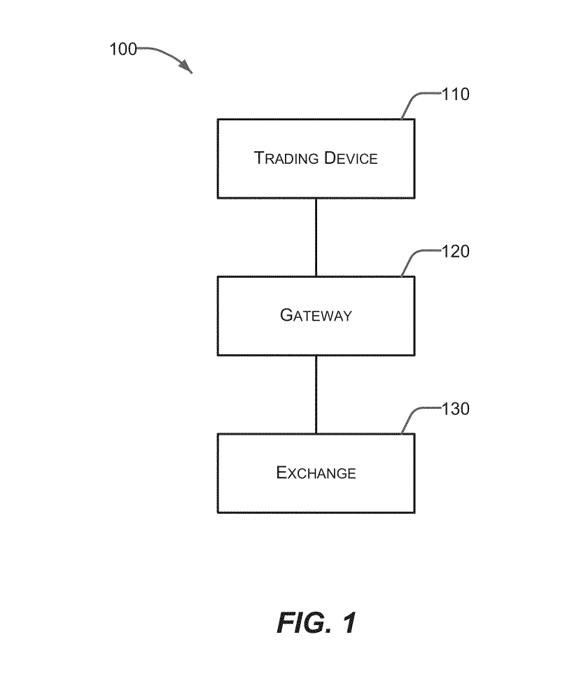

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradable objects to the exchange 130.

Market data may include data about a market for a tradable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth. A market condition is a quality of a market such as trend, volatility, sentiment, volume of trading, etc.

A tradable object is anything which may be traded. For example, a certain quantity of the tradable object may be bought or sold for a particular price. A tradable object may include, for example, financial products, stocks, options, bonds, future contracts, currency, warrants, funds derivatives, securities, commodities, swaps, interest rate products, index-based products, traded events, goods, or a combination thereof. A tradable object may include a product listed and/or administered by an exchange (for example, the exchange 130), a product defined by the user, a combination of real or synthetic products, or a combination thereof. One or more tradable objects may be organized according to one or more rules to define a trading strategy, for example. There may be a synthetic tradable object that corresponds and/or is similar to a real tradable object.

An order message is a message that includes a trade order. A trade order may be, for example, a command to place an order to buy or sell a tradable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold. The exchange 130 may include separate entities, some of which list and/or administer tradable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

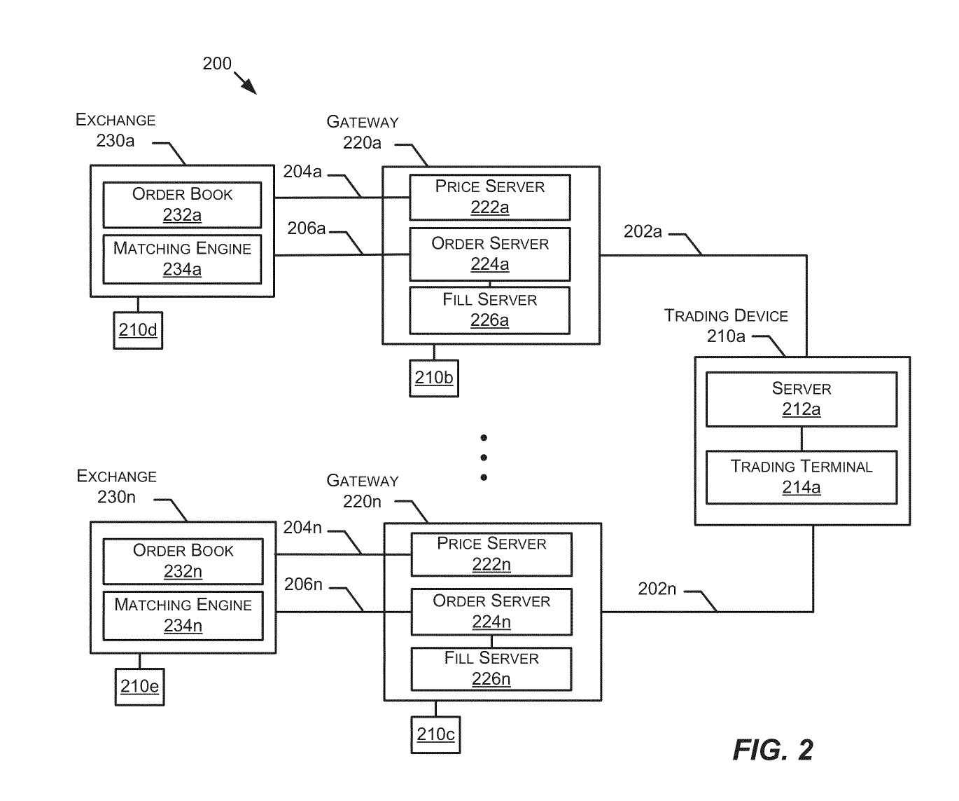

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. EXAMPLE COMPUTING DEVICE

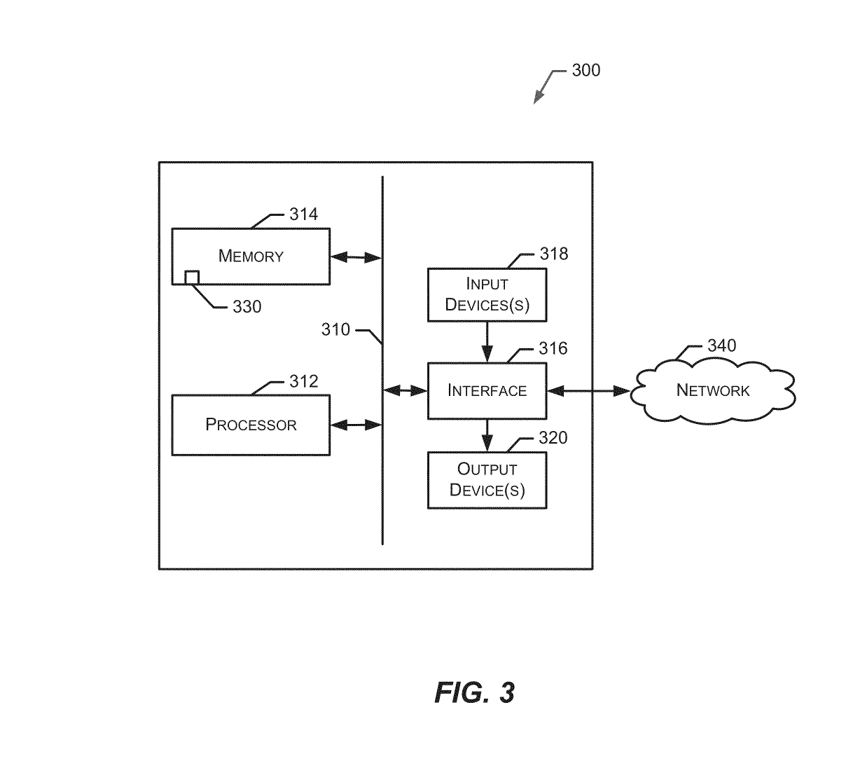

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. EXAMPLE ADJUSTABLE TRADING INTERFACE

Trading interfaces are configured to present information regarding a market for a tradable object in an efficient and convenient manner. Market information is displayed for review and interaction via a trading interface. For example, a trading interface may be configured to present information such as market depth, inside market (e.g., highest bid price and lowest ask price), and alternative bid and ask price positions. A well-organized trading interface can provide traders with a significant advantage by displaying the market depth such that trends in the orders working in the market can be easily discerned. The market depth display shows the trader the interest the market has in a given commodity at different price levels. If a large amount of bids or asks are in the market near the trader's position, the trader may feel that it would be advantageous to sell or buy before the inside market reaches the morass of orders. A lack of orders above or below the inside market might prompt a trader to enter orders near the inside market. Without seeing the market depth, no such strategies could be utilized. Thus, improvements in the display of information can help traders to analyze the market as well as increase the speed of their trading activity and likelihood of entering orders at desired prices with desired quantities.

A trading device, such as trading device 110 and/or 210a, can include a terminal, such as trading terminal 214a, with a display screen showing one or more trading interface windows. A trading interface window displays a bid quantity, ask quantity, price, last traded quantity, etc. The trading interface window displays market depth on a vertical or horizontal plane, which fluctuates logically up or down, left or right across the plane as the market prices fluctuates. This allows placement of trade orders quickly and efficiently. A commodity's market depth is represented by current bid and ask prices and quantities in the market. Each available trading interface window can facilitate a trade (e.g., buy and/or sell) on a given market. Interaction with a trading interface window can be facilitated through selection of an element of the trading interface window by a cursor. Each element or “target” of a trading interface window may correspond to a quantity to be bought or sold at a given price level, for example.

For example, using the trading interface window, a trade can be executed by positioning a cursor with respect to the interface and selecting a corresponding target via action such as a single click of a button on a computer mouse, trackball, touch pad, etc. One or more algorithms and mapping tables can be used to facilitate processing, mapping and display of information such as price, order and fill information for a trade on an exchange. The trading interface window helps facilitate exchange of such information between the trading device and the exchange, for example.

Speed can be important when navigating a trading interface window to help ensure that a desire trade is executed at a desired price for a desired quantity. However, moving a cursor over a long distance and then clicking on a relatively small element or target can take a large amount of time when compared to a speed at which a market may move. Such a movement and interaction (e.g., a mouse click, touch pad select, etc.) can take thousands of milliseconds to execute, for example.

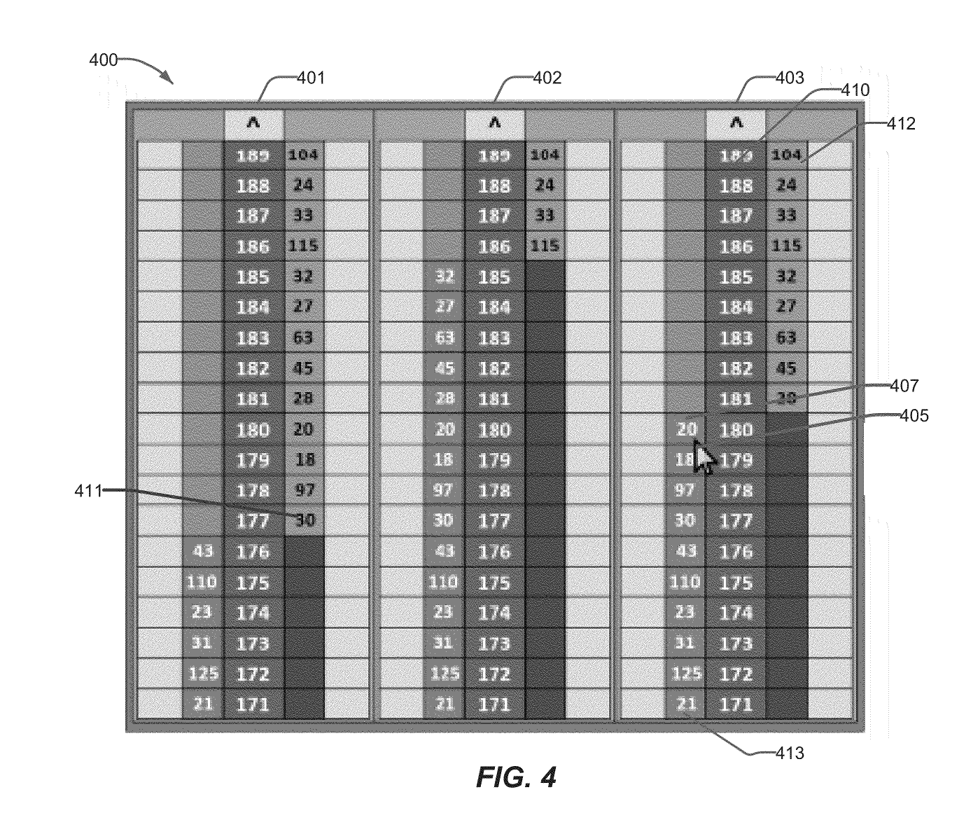

FIG. 4 illustrates an example layout of three (3) trading interface windows 401-403 on a display screen 400. The three trading interface windows 401-403 occupy the full display screen 400. As demonstrated in the example of FIG. 4, a cursor 405 is positioned on the third trading interface window 403 at a location 407 that indicates the availability of 20 bids at a price level of 180.

In the example display of FIG. 4, a static vertical column of prices 410 is provided with the bid 411 and ask 413 quantities displayed in vertical columns to either side of the price column 410 and aligned with corresponding bid and ask prices. The trading interface windows 401-403 show representative ticks from prices for a given tradable object, for example. A column may not list a whole price but, rather, may list a certain number of digits of the price, a certain defined increment, a certain number of ticks, etc. In certain embodiments, the columns 410, 412 and 413 are shown in different colors so that they can quickly be distinguished.

In certain embodiments, values in the price column 410 are static; that is, they do not normally change positions unless a re-centering command is received. In still other embodiments, the price column 410 may be configured to automatically re-center as the market moves. Values in the Bid 413 and Ask 412 columns however, are dynamic; that is, they move up and down (in the vertical example) to reflect the market depth for the given commodity. Blanks in a column indicate that no orders are entered or working at that price. In certain embodiments, prices and quantities for the inside market and market depth update dynamically on a real time basis as such information is relayed from the market.

In certain embodiments, the current position (e.g., location 407) of the cursor 405 with respect to the trading interface windows 401-403 can be used to predict subsequent desirable and/or likely targets. For example, location(s) near the inside market are more likely targets than targets corresponding to price levels farther away. Additionally, a trader's current position in a market affects a next likely target in the interface window. For example, if the trader is already long (or short) in a market, the trader is more (or less) likely to target an offer (or bid).

Certain embodiments provide a dynamic, adjustable set of probabilities corresponding to a likelihood of each potential target for cursor movement and interaction. Certain embodiments dynamically modify a layout of a trading interface to help enable faster movement of a cursor to target location(s) that are more probable.

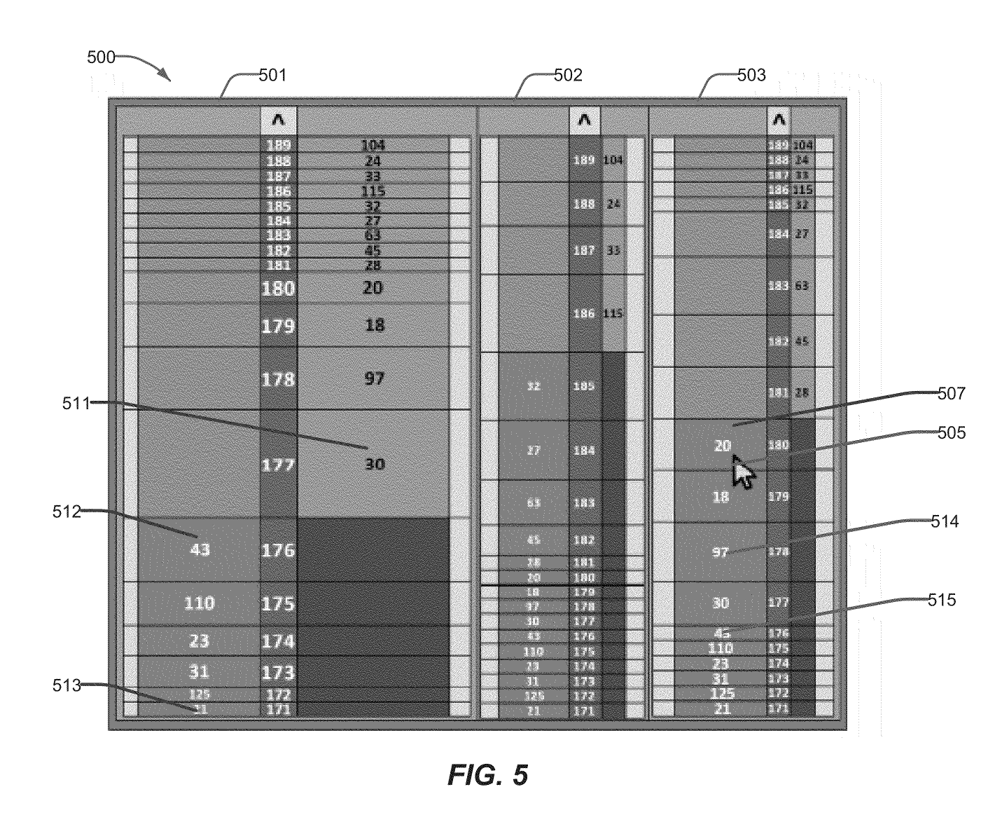

FIG. 5 illustrates an example dynamically adjusted layout of three (3) trading interface windows 501-503 on a display screen 500. As shown in the example of FIG. 5, the trading interface windows 501-503 have undergone dynamically adjusted “elastic” interface layout modification, which impacts an allocation of available space on the display screen 500 to each window 501-503.

The example of FIG. 5 shows a cursor 505 at a first or current position 507 in the trading interface window 503. As shown in FIG. 5, the horizontal (X) width and vertical (Y) height of the graphical user interface (GUI) elements representing locations 511, 512, 514 are increased in direct proportion to the likelihood that an individual location is the next target. Similarly, the X and Y dimensions of the GUI elements representing locations 513, 515 are reduced to indicate a decreased likelihood of selection. Thus, the X and Y dimensions of each GUI element may be dynamically adjusted to reflect a determined likelihood of subsequent selection. For example, location 511 at the price level 177 in window 501 is more likely to be selected next than location 512 at the price level 176 in window 501, so the GUI element representing location 511 is larger than the GUI element representing location 512. However, location 512 is more likely to be selected next than location 513 for price level 171 in window 502, so the GUI element representing location 512 is larger than the GUI element representing location 513. Similarly, location 514 in window 503 is more likely to be next selected than location 515 in window 503, so the GUI element representing location 514 is allocated more display real estate than the GUI element representing location 515, for example.

For example, utilizing dynamically adjusted elements within the trading interface windows 501-503, a user can easily and quickly move the cursor 505 from the current location 507 to a target in the leftmost trading interface window 501. In the illustrated example of FIG. 5, the target at location 511 has been determined to have the highest likelihood of selection subsequent to the target at location 507. In order to expedite selection of the target at location 511, the X and Y dimension of the GUI element representing location 511 have been increased. Thus, the size of the likely target is increased to simplify the identification and selection of the desired. By way of contrast, the size of the target at location 411 in FIG. 4 remains constant making it more difficult to select the smaller sized GUI element. In this way, certain embodiments dynamically determine an improved (e.g., optimal) interface layout at a point in time and define one or more modes of behavior to dynamically and elastically adjust the interface layout smoothly without confusing the user or disrupting trading.

A variety of algorithms and/or other techniques can be applied to cursor position in a trading interface window to determine one or more likely next target destination(s). For example, human-computer interaction includes a measure of time taken for mouse movement of a cursor from one point to another. For example, Fitts' law can be used to measure and predict how long it will take for a user to move a mouse from one location to another and to click on a target selection choice. Fitts' law predicts that a time to rapidly move to a target area is a function of a distance to a target and a size of the target. Fitts' law can be represented as:

$$M T = a + b {log}_{2} ( 1 + \frac{A}{w} ) . \qquad ( Eq . 1 )$$

In equation 1, “MT” represents a movement time to a target that is a distance “A” away from a current cursor position and which has a width “w” measured in a direction of motion to the target. Equation 1 also includes two constants “a” and “b”, which can be determined, for example, by regression on a set of data samples. Constants “a” and “b” may correspond to start/stop time of cursor movement and inherent speed of cursor movement, respectively, and may be on the order of 100-400 milliseconds (ms), for example. In certain embodiments, when the cursor's approach angle is not aligned with sides of a rectangular target, a minimum of height and width of the target can substitute for “w” in Equation 1.

In certain embodiments, a cursor position C=(Cx, Cy) has coordinates Cx and Cy, and a set of potential target locations T={Tᵢ=(Txᵢ, Tyᵢ, Twᵢ, Thᵢ)} includes Txᵢ, Tyᵢ, as x and y coordinates of the center of the ith target, Twᵢ, Thᵢ as width and height of the ith target. A set of probabilities P={pᵢ} represents a probability of a next interaction being a move to and selection of (e.g., clicking on, etc.) target Ti. An Expected Movement Time (EMT) to move the cursor to a target and select that target can be reduced or minimized by varying Txᵢ, Tyᵢ, Twᵢ, Thᵢ subject to one or more layout constraints, for example. EMT can be determined by:

$$\begin{matrix}E M T = {\sum }_{i} {p}_{i} \times M T ( {C}_{i} {T}_{i} ) , \\ where & ( Eq . 2 ) \\ M T ( {C}_{i} {T}_{i} ) = a + b {log}_{2} ( 1 + \frac{\sqrt{{( Cx - {Tx}_{i} )}^{2} + {( Cy - {Ty}_{i} )}^{2}}}{min ( {Tw}_{i} , {Th}_{i} )} ) . & ( Eq . 3 )\end{matrix}$$

Using equations 2 and 3 above, expected movement times from a current cursor position to one or more selected targets can be determined. A processor, such as processor 312 at trading device 110, 210a, can compute an EMT using the equations and apply the EMT to one or more probable targets displaying via the trading interface window. Based on calculated EMT, taken alone or in conjunction with other factors, an indication of at least one probable next cursor position can be provided via the interface. For example, portions of the interface can be adjusted dynamically to enhance, expand, and/or otherwise ease movement of the cursor to one more likely targets (e.g., probable next cursor positions). A degree of enlargement of a candidate location can be proportional to a likelihood that the candidate location is the next cursor position, for example. For example, the more likely that a target location is the next cursor position, the more that location is enlarged with respect to other locations in the interface. As another example, location(s) on the interface corresponding to one or more probable next cursor positions can be highlighted, colored differently, bordered differently, etc., from other interface locations to indicate that each location is a probable next cursor position on the trading interface.

Layout constraints may take a variety of forms. For purposes of example illustration only, layout constraints include the following, which are designed to keep an elastic layout looking reasonably similar to an unmodified interface for ease of comprehension by a trader. By applying one or more layout modification constraints to re-rendering of a trading interface, a user can still recognize the re-rendered interface as a modification of the unmodified trading interface.

For example, connectedness is to be maintained between adjustments in display of a trading layout. That is, if two targets are connected (e.g., touching) in an inelastic state of the layout, then the targets are to still be connected in an elastic or expanded state of the layout. Additionally, if two targets are at a same x and/or y position in the inelastic state, then the targets are to be at the same x and/or y position after relocation in the elastic state, for example.

In certain embodiments, a minimum size can be specified and maintained regardless of a default or expanded state of the interface. For example, target and/or non-target regions of a trading interface may have a defined minimum size that the region cannot be decreased beyond. A size limit can be expressed as an absolute size value for a display element, a percentage of original element size, etc. In certain embodiments, adjustment of other dimensions of the interface can be restricted. For example, a total height and/or width of a re-rendered trading interface may be restricted to the same total height and/or width of the trading interface prior to re-rendering.

In certain embodiments, solving Equation 2 subject to one or more constraints such as example constraints disclosed above can be accomplished using a constraint satisfaction method such as simulated annealing.

In certain embodiments, a dynamic elastic interface layout modification can be applied to a single window, a combination of windows, all windows on a display screen, a plurality of windows on multiple displays, all windows on multiple displays (e.g., in a multi-monitor set up), and so on.

Adjustment of the trading interface layout can be restricted and/or otherwise affected based on market condition, trading strategy, order(s) seeking fill, etc. In certain embodiments, dynamic adjustment of a trading interface is constrained by a type of transaction being pursued. For example, if a trading interface window is being used in an attempt to complete a second leg of a trading strategy, target(s) adjusted for better selection in that window should comport with the second leg. Other target(s) may remain the same size or be reduced in size, for example.

Dynamic, elastic interface layout modification can be applied at a variety of different times. For example, layout modification can occur automatically upon movement of a cursor. Layout modification can occur via a smooth animation from a last interface layout to a calculated interface layout, for example. Layout modification can occur after the cursor has come to rest by an “instant” change and/or smooth animation from inelastic state to modified elastic state, for example. Layout modification of the interface can occur upon cursor movement (e.g., via a single update (“instantly”) or via animated change to a modified state), adjusting probabilities to increase interface zones in a direction of cursor movement and decrease interface zones away from a direction of cursor movement, for example.

A set of probabilities for a next cursor location can be determined via a rule set for a given trading interface, for example. The set of probabilities can include factors such as trading strategy, a location of the inside market, a current market movement direction, location of working order(s) placed, volatility of prices on different products, statistics learned from current and/or previous session(s) regarding what type(s) of location(s) are more likely locations of interest, etc.

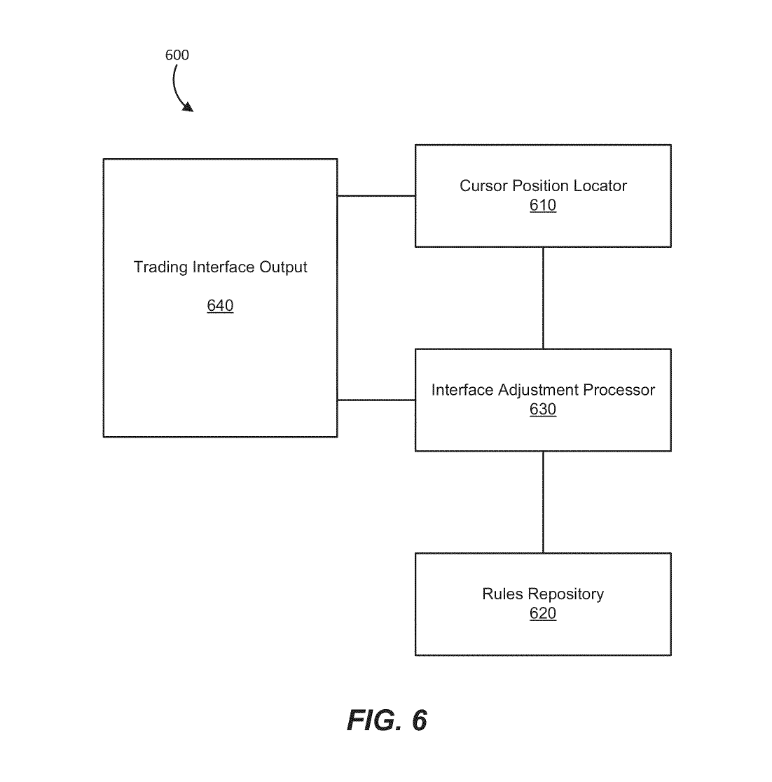

FIG. 6 illustrates a block diagram representative of an example trading interface adjustment system 600. The example adjustment system 600 can be used to dynamically modify or alter one or more trading interface windows such as those shown in FIG. 4 and/or FIG. 5, for example. The example trading interface adjustment system 600 includes a cursor position locator 610, a rules repository 620, an interface adjustment processor 630, and a trading interface output 640. While a trading interface is used as an example, certain embodiments apply to a plurality of interfaces having a plurality of locations or cells for information display and user selection.

The example trading interface adjustment system 600 facilitates display and modification of one or more trading interface windows, such as windows 401, 402, 403, 501, 502, and 503, via the trading interface output 640. The cursor position locator 610 obtains position information for a displayed cursor with respect to a coordinate system associated with the trading interface output 640.

Based on the obtained cursor position information, the interface adjustment processor 630 analyzes the obtained cursor position information based on one or more rules from the rules repository 620. The interface adjustment processor 630 identifies one or more potential targets for a next cursor position with respect to a trading interface window. Potential target(s) can be identified using one or more algorithms or rules stored in the rules repository 620, for example. As discussed above, one or more equations such as Fitts' law can be applied to measure and predict a range and timing of cursor movement to identify one or more potential targets within a range of the current cursor position, for example. Equations 2 and 3 can be used to generate expected movement time to move the cursor to a target, for example.

The interface adjustment processor 630 can apply further constraints based on layout and/or market, for example. One or more factors such as inside market, market depth, trading strategy, spatial relationship, etc., can be used by the interface adjustment processor 630 and the rules repository 620 to identify one or more potential targets given a current cursor position.

Once potential target(s) have been determined, the interface adjustment processor 630 generates one or more adjustments to the trading interface output 640. For example, GUI elements that comprise the trading interface window layout are dynamically modified to accentuate or otherwise increase the ease of which the cursor can be positioned next at one of the potential target location(s) on a trading interface window provided by the trading interface output 640. Alternatively or in addition, GUI elements can be highlighted, colored differently, provided with different border, etc., to cause GUI elements corresponding to probable next cursor position(s) to stand out or otherwise be more easily accessible for cursor positioning. The cursor position locator 610 then identifies a new position of the cursor and continues to work with the interface adjustment processor 630 and leverage the rules repository 620 to elastically update a layout of the trading interface output 640.

### VI. EXAMPLE METHODS To DYNAMICALLY ADJUST A TRADING INTERFACE

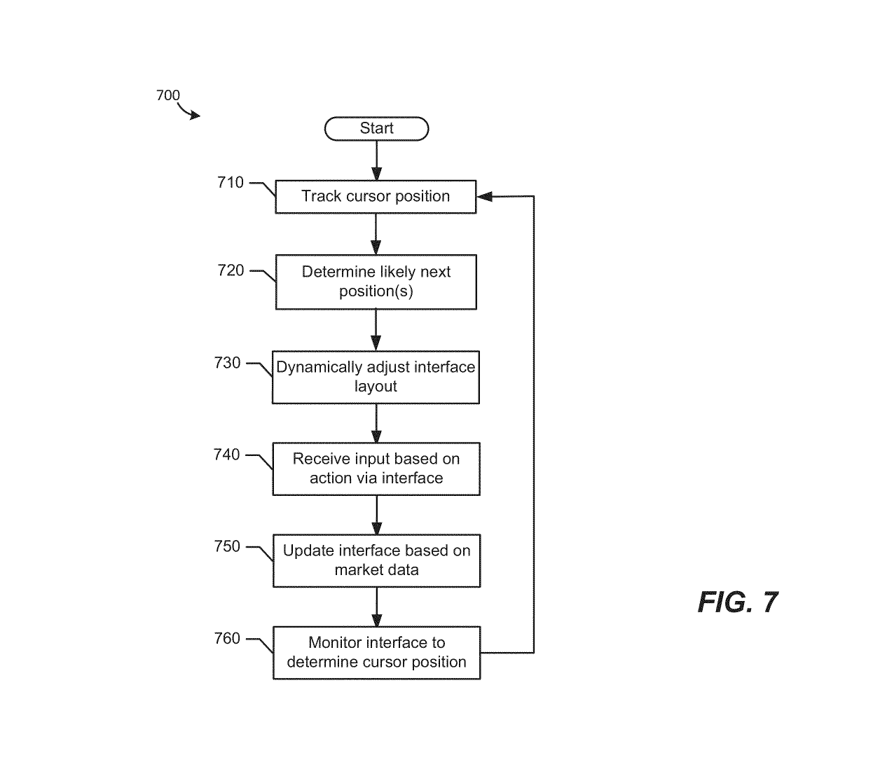

FIG. 7 illustrates a flow diagram of an example method 700 to dynamically adjust a trading interface based on current and probable next cursor position. At block 710, position of a cursor is tracked with respect to a trading interface displayed on a display. For example, current cursor position with respect to a displayed trading interface window is determined and followed. A current position of the cursor can be determined via a software query of displayed cursor position on the interface (e.g., using a position property of a cursor class), via a hardware query of the mouse or other positioning device used to position the cursor with respect to the displayed interface, and so on. Position may be given in an X, Y coordinate format with respect to a reference coordinate system, reference point, etc.

At block 720, one or more likely positions (e.g., “targets” or “candidate locations”) on the trading interface are determined based on current cursor position. For example, if the cursor is currently positioned at the bid of the inside market, locations near the inside market may be identified as more likely targets than targets corresponding to price levels further away. Additionally, for example, a trader's current position in the market can affect a likely next target (e.g., a bid or an ask) on the trading interface. One or more rules and/or processes, such as an EMT based on Fitts' law, can be used to generate probable next cursor position(s) based on the currently measured cursor position, for example.

At block 730, layout of the trading interface is dynamically adjusted. For example, the trading interface layout can be made “elastic” to be dynamically stretched, expanded, shrunk, etc., to suit a particular trading strategy. Based on one or more likely candidate locations for next cursor position, the trading interface layout can be altered (e.g., within a same overall form factor) to expand likely candidate locations and shrink other unlikely locations for next cursor position, for example. A degree of enlargement of a candidate location can be proportional to a likelihood that the candidate location is the next cursor position, for example. For example, the more likely that a target location is the next cursor position, the more that location is enlarged with respect to other locations in the interface. Alternatively or in addition, portion(s) of the trading interface can be highlighted, colored differently, provided with different border, etc., to cause the portion(s) of the trading interface layout corresponding to probable next cursor position(s) to stand out or otherwise be more easily accessible for cursor positioning.

At block 740, input is received based on action via the trading interface. For example, a bid or ask price is selected via the trading interface to facilitate all or part of a trading. At block 750, the trading interface is updated based on updated market data. For example, a completed buy or sell order results in updated market data which is then reflected on the displayed trading interface.

At block 760, the trading interface is monitored to determine cursor position. That is, the process 700 repeats as the cursor is monitored to determine current position and likely next position, for example.

Thus, certain embodiments provide dynamic and elastic layout calculation based on current cursor position. Certain embodiments provide dynamic determination of probabilities associated with each potential target. Certain embodiments provide trading scenario-specific rules to adjust and/or determine probabilities. Certain embodiments provide incorporation of specific constraint sets to influence the dynamic and elastic layout calculations. Certain embodiments facilitate determination of probabilities and/or factors affecting probabilities using a machine learning process on a user and/or set of users, for example.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method comprising:
detecting, using a computing device, a current position of a cursor with respect to a trading interface;
evaluating, using the computing device, one or more candidate locations in the trading interface to determine at least one probable next cursor position based on at least one rule and at least one market condition; and
providing an indication of the at least one probable next cursor position via the trading interface.

2. The method of claim 1, wherein the at least one market condition comprises at least one of a market position, an inside market, and a trading strategy being executed.

3. The method of claim 1, wherein the at least one market condition comprises an outstanding order for the market shown in the trading interface.

4. There method of claim 1, wherein the at least one market condition comprises current bid and ask prices and available trade quantity.

5. The method of claim 1, wherein the indication of the at least one probable next cursor position comprises an adjustment of the trading interface based on the one or more probable next cursor positions to enlarge at least one of the one or more probable next cursor positions in the trading interface.

6. The method of claim 1, wherein evaluating further comprises evaluating one or more candidate locations based on a set of probabilities determined by a rule set associated with the trading interface.

7. A system comprising:
a computing device configured to detect a current position of a cursor with respect to a trading interface, the computing device configured to evaluate one or more candidate locations in the trading interface to determine at least one probable next cursor position based on at least one rule and at least one market condition and to provide an indication of the at least one probable next cursor position via the trading interface.

8. The system of claim 7, wherein the at least one market condition comprises at least one of a market position, an inside market, and a trading strategy being executed.

9. The system of claim 7, wherein the at least one market condition comprises an outstanding order for the market shown in the trading interface.

10. There system of claim 7, wherein the at least one market condition comprises current bid and ask prices and available trade quantity.

11. The system of claim 7, wherein each element of a displayed trading interface corresponds to a quantity to be bought or sold at a given price level.

12. The system of claim 7, wherein the indication of the at least one probable next cursor position comprises an adjustment of the trading interface based on the one or more probable next cursor positions to enlarge at least one of the one or more probable next cursor positions in the trading interface.

13. The system of claim 7, wherein the computing device is to evaluate one or more candidate locations based on a set of probabilities determined by a rule set associated with the trading interface.

14. The system of claim 7, wherein the trading interface includes a plurality of trading interface windows.

15. A tangible computer-readable storage medium comprising instructions that, when executed, cause a computing device to:
detect a current position of a cursor with respect to a trading interface;
evaluate one or more candidate locations in the trading interface to determine at least one probable next cursor position based on at least one rule and at least one market condition; and
provide an indication of the at least one probable next cursor position via the trading interface.

16. The computer-readable storage medium of claim 15, wherein the at least one market condition comprises at least one of a market position, an inside market, and a trading strategy being executed.

17. The computer-readable storage medium of claim 15, wherein the at least one market condition comprises an outstanding order for the market shown in the trading interface.

18. The computer-readable storage medium of claim 15, wherein the at least one market condition comprises current bid and ask prices and available trade quantity.

19. The computer-readable storage medium of claim 15, wherein the indication of the at least one probable next cursor position comprises an adjustment of the trading interface based on the one or more probable next cursor positions to enlarge at least one of the one or more probable next cursor positions in the trading interface.

20. The computer-readable storage medium of claim 15, wherein evaluate further comprises to evaluate one or more candidate locations based on a set of probabilities determined by a rule set associated with the trading interface.

21. The computer-readable storage medium of claim 15, wherein the trading interface includes a plurality of trading interface windows.

22-81. (canceled)
